(19) United States
(12) Patent Application Publication
(10) Pub. No.: US 2010/0059239 A1
(43) Pub. Date: Mar. 11, 2010

(54) SUPPORTED CHANGEABLE FRAME FOR SOIL WORKING IMPLEMENTS

(75) Inventor: Ole Green, Lem St. (DK)

Correspondence Address: KNOBBE MARTENS OLSON & BEAR LLP, 2040 MAIN STREET, FOURTEENTH FLOOR, IRVINE, CA, 92614, US

(73) Assignee: AARHUS UNIVERSITET, Aarhus C (DK)

(21) Appl. No.: 12/514,998

(22) PCT Filed: Oct. 9, 2007
(86) PCT No.: PCT/DK07/00438

§ 371 Date: Nov. 18, 2009

(30) Foreign Application Priority Data
Nov. 20, 2006 (DK) PA 2006 01515

(51) Int. Cl. A01B 59/04; A01B 79/00

(52) U.S. Cl. 172/1; 172/324

(57) ABSTRACT

A system (202) is disclosed with a frame (204) with a plurality pivotable connected frame sections (214, 216, 220, 502), the frame (204) being operable in a number of positions (206, 302) and changeable between these, and a length adjustable connection (232) between at least one of the frame sections and a dragging device (212), wherein the length adjustable connection (232) is arranged in an angle (234) and a length (244) of the length adjustable connection is controlled so as to obtain drag forces created by working the soil, and the length adjustable connection (232) is so arranged that changing the length (244) of the length adjustable connection at least partly supports and at least partly powers a change of the position (206, 302) of the frame in order e.g. to provide an improved relation between a transport width and a soil working width of the frame (204) and for supporting, controlling and changing between multiple positions (206, 302).

### FIELD OF THE INVENTION

The present invention relates to a frame for soil working implements, and in particular to a supported frame which is changeable between a transport position and a soil working position.

### BACKGROUND OF THE INVENTION

The need of soil to be worked or tilled such as cultivated, fertilized or other similar soil working operations on the soil in connection with e.g. planting of crops or in connection with farming in general has been accomplished since the earliest days of civilization.

U.S. Pat. No. 1,170,269 discloses a grading machine comprising a portable frame combined with a plurality of substantially alined grading blades extending transversely of the frame. The grading machine has means hingedly connecting the adjacent ends of the several blades, draft connections between the latter and the frame, means to swing the various blades forwardly and rearwardly around their hinges, and additionally means to vary the upright positions of said blades.

AU 28161/67 discloses a cultivator implement having a draw frame mounted on ground wheels, comprising a main implement support frame and side extension implement support frames attached to said main frame for movement between an extended working position and a folded transport position supported on the draw frame. The side extension frames are articulated with said main frame by means of a pivot, cable means connected between the outer ends of said extension frames and a winch means located at the forward end of said draw frame. Support means for said extension frames are extending transversely of said draw frame and means on said extension frames adapted to engage said support means to assist movement of said extension frames up onto said support means.

More recently, soil working devices have increased in complexity and size, depending on factors such as the type of farming operation, the crops, the quantity and type of soil being operated on or the agricultural tractors available. There has also been an increased emphasis on conserving natural resources resulting in these concerns being integrated in modern tillage systems.

Furthermore, environmental considerations are taken into account such as when having to spread a given amount of fertilizer or slurry to a given area of soil. These concerns have resulted in larger soil working systems, e.g. also in working width, and more complex soil working systems that assist in achieving these goals. A larger tillage system allows a single operator to perform tillage operations on a greater area.

More sophisticated systems possibly further allow for the accomplishment of tilling, planting and fertilizing in a single pass of the tillage device or cultivator through the field. However, these larger and more complex tillage systems create further complexities.

Also, to transport the frame to be used for the farming operations it was also necessary for the device to be capable of being collapsed, folded or changed to a width sufficient small to be transported when having to transport the frame to and from a place of farming.

To accomplish one or more of these objects, a frame with a centre section and with a set of pivotable or foldable inner frame sections extending from the centre section is known from the prior art. The inner frame sections pivot relative to the centre section, thus allowing the frame to accommodate some undulations in the ground. The inner frame sections may also be folded into the centre section allowing for easy transport before and after performing the farming operations. Possibly, an outer set of frame sections is added, thus increasing the width of the frame. Taking into account the weight of the frame, hydraulic systems are normally used to provide changes of the width of the frame between a transport position and a soil working position.

In the view of the present inventor, such frames and systems for changing the frame between a transport position and a working position present a number of disadvantages.

As an example of such disadvantages, an increased width, possibly due to the width of a single centre frame section, and in particular possibly due to the additional inner and outer frame sections and the width of these, create large additional draft forces on the frame structure, such as forces on the hinges of the frame and also forces in connections between the frame and a frame carrier and/or in a connection between the frame and the tractor.

The draft forces are forces that are created such as when a soil working implement is dragged through the soil or when an implement is dragged over the soil or when an implement is rolled over the soil. Furthermore, forces in connection with changing the frame between the transport position and soil working position will occur. Still further, in order to change the frame between a transport position and a soil working position, sturdy hydraulic systems, often with long hoses for hydraulic oil, is needed, and which poses additional challenges.

The inventor of the present invention has realized that an improved system and method for providing an improved possible relation between a transport width and a soil working width of a frame and for supporting, controlling and changing between multiple positions of a frame is of benefit, and has in consequence devised the present invention.

### SUMMARY OF THE INVENTION

It may be seen as an object of the present invention to provide a system with a frame having an improved relation between a transport width and a soil-working width of the frame while providing a system and method for supporting, controlling and changing between at least a transport position and a soil working position of the frame, preferably between multiple positions of the frame. Preferably, the invention alleviates, mitigates or eliminates one or more of the above or other disadvantages singly or in any combination.

Accordingly there is provided, in a first aspect of the invention, a system for supporting, controlling and changing between multiple positions of a frame, the frame being intended for being dragged by a dragging device and for use with agricultural soil working implements connected with the frame, the soil working implements creating drag forces when used, the system comprising
the frame comprising a plurality pivotable connected frame sections, the frame being operable in a number of positions and changeable between these positions, and
a length adjustable connection between at least one of the frame sections and the dragging device, wherein
the length adjustable connection is arranged in an angle and a length of the length adjustable connection is controlled so as to obtain drag forces from the soil working implements, and
wherein the length adjustable connection is so arranged that changing the length of the length adjustable connection at least partly supports and at least partly powers a change of the position of the frame.

Thus a system is provided which improves the relation between the transport width in a transport position of the system and the working width in a working position of the system. The improved relation is among others due to the multiple sections, but in case of the present invention the width of each section and/or the number of sections may be increased compared to known multiple frame section systems. The reason for the improved relation is, among others, that the length adjustable connection is controlled in length to obtain at least part of the drag forces from the soil working implements.

Obtaining at least part of the drag forces with the length adjustable connection and also using the length adjustable connection during change of positions result in, as a possible advantage, the frame construction being provided with less weight and/or less constructional complexity of the pivotable connections and/or in the frame itself and/or in the connection between the centre section and the dragging device.

Furthermore, increasing the width of a frame and solely using e.g. hydraulic solutions as in prior art systems to change the position of the frame often results in long hydraulic lines running along the frame construction. Not necessarily needing these hydraulic lines or needing less of such lines, as for the present invention, e.g. also reduces the weight and constructional complexity of the frame, enabling an increased working width of the frame compared to known systems and therefore an improved relation between the transport and the working width.

When furthermore using and controlling the length of the length adjustable connection at least partly to assist and power a change of the frame as will be described further herein, a possible advantage is that even less constructional complexity of the frame and e.g. an eventual hydraulic system is needed, and hereby a possible advantage may be that the working width of the frame is further increased compared to known multiple frame section solutions. An increased working width can be preferred in order to work a larger area of soil while e.g. being able to drive through an area to be worked a limited number of times with the dragging device and the frame, thus reducing possible crop and/or soil damage.

Especially, the present invention makes it possible to use soil working implements, creating relative large drag forces when used, and hereby e.g. using the same track lines as used with implements creating less drag forces. Hereby, a possibility of e.g. spreading slurry by or while using implements creating relative large drag forces, possibly using the same tracks in a field as with other implements creating less drag forces, is provided.

The system is therefore, as an example, a possible improved alternative to soil working such as spreading slurry using a system with a frame with hoses provided along the frame and spreading the slurry more or less on top of the soil, creating less drag forces, however such hose system creating other problems prevented by the present invention.

The frame may comprise a centre frame section having a left and right side end and the centre frame section is provided for being connected to the dragging device, and one or more additional frame sections pivotable connected by one or more pivotable connections to the centre frame in at least one of the left and right side end of the centre frame, and the length adjustable connection is arranged in an angle between the additional frame sections and the dragging machine and the length of the length adjustable connection is controlled so as to obtain drag forces from the soil working implements, and the length adjustable connection is so arranged that changing the length of the length adjustable connection at least partly supports and at least partly powers a change of the frame in both horizontal and vertical planes.

A possible advantage is that a frame which can be folded in different planes, such as in both a horizontal plane and a vertical plane when frame is on a horizontally leveled ground, is provided with simple and possibly relative light-weighted means and a further improved relation between the transport position and the working position is provided.

The length adjustable connection may be so arranged and operated that changing the length of the length adjustable connection at least partly assists and at least partly powers the change of the frame in different panes, such as in both a horizontal plane and a vertical plane, when changing the frame between the working position and the transport position, a system at least partly assisting, controlling and powering a change of the frame in two planes between at least two positions is provided.

Hereby, an even further improved relation between the transport position and the working position is provided. Similarly, when arranging and operating the length adjustable connection so that changing the length of the length adjustable connection at least partly assists and at least partly powers the change of the frame in different planes, such as both in a horizontal plane and a vertical plane, when changing the frame both to and from the working position and to and from the transport position still further improvement is provided.

One or more pivotable connections may be constructed and can be operated so as to be locked or unlocked in one or more directions. A possible advantage may be that further control, when maintaining or changing a position of a frame section, is provided. The pivotable connections can be locked or unlocked in the different planes, such as in a horizontal plane or a vertical plane, and/or disabling or enabling the connected frame sections from an angular rotation in one or both different planes, such as in one or both of the horizontal plane and the vertical plane.

According to embodiments in accordance with the invention, the centre frame section is provided for extending in a substantially horizontal direction substantially perpendicular to a travelling direction of the dragging device, and/or the additional frames comprises a first frame section having first and second opposing ends and being pivotable connected to the centre frame section on one side of the centre frame in the first end, and a second frame section having first and second opposing ends and being pivotable connected to the second end of the first frame section in the first end.

Additionally or alternatively, the length adjustable connection is connected between an outer end of one of the one or more additional frame sections and the dragging device, and/or the length of the length adjustable connection is adjusted by changing a length of a flexible but substantially non-extendable line, such as a wire, connected between one of the one or more additional frame sections and the dragging device

The frame may be provided for being connected to a dragging device selected among the following group of dragging devices: a frame carrier, a self propelled frame carrier, an agricultural tractor, a frame carrier to be drawn by an agricultural tractor.

A connection between the frame and the dragging device may be selected among the following group of connections: a pivotable connection, a non-pivotable but releasable connection, a fixed non-releasable connection, a hitching device, a three point hitching device.

In a second aspect of the invention there is provided a control system for operating a system in accordance with the present invention and embodiments of the system so as to adjust the length of the length adjustable connection in order to provide a system which is capable of obtaining drag forces and capable of at least partly assisting and at least partly powering a change of the position of the frame.

In a third aspect of the invention there is provided a method for supporting, controlling and changing between multiple positions of a frame in a system, the frame being intended for being dragged by a dragging device and for use with agricultural soil working implements connected with the frame, the soil working implements creating drag forces when used, the system comprising a frame comprising a plurality pivotable connected frame sections, the frame being operable in a number of positions and changeable between these positions, and a length adjustable connection between at least one of the frame sections and the dragging device, the method comprising arranging the length adjustable connection and controlling the length of the length adjustable connection so as to obtain drag forces from the soil working implements, and changing the length of the length adjustable connection so as to at least partly support and at least partly power a change of the position of the frame.

In general, by writing that ‘it is an advantage’ by the present invention and referring to an advantage, it must be understood that this advantage may be seen as a possible advantage provided by the invention, but it may also be understood that the invention is particularly, but not exclusively, advantageous for obtaining the described advantage.

In general, the various aspects and advantages of the invention and the embodiments of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 is a prior art system with a frame intended for being dragged by a dragging device and for use with agricultural soil working implements connected with the frame.

FIG. 2 is a perspective view of a first embodiment of a system in a working position in accordance with the present invention.

FIG. 3 is a perspective view of the first embodiment of the system in a transport position in accordance with the present invention.

FIG. 4 is a top view of the first embodiment of the system in the working position and in the transport position in accordance with the present invention.

FIG. 5 shows a second embodiment of a system in a working position in accordance with the present invention.

FIGS. 6a and 6b show drawings in perspective views of the first embodiment in accordance with the invention and its embodiments.

FIGS. 7a and 7b show drawings in a side and top view of the first embodiment in accordance with the invention and its embodiments,

FIG. 8a, FIG. 8b and FIG. 8c is a perspective view of a preferred embodiment of the invention in different positions, a working position and different transport positions, and

FIG. 9 shows in perspective a connection between a centre frame section and a first frame section accordance with the invention and the preferred embodiment.

### DESCRIPTION OF EMBODIMENTS

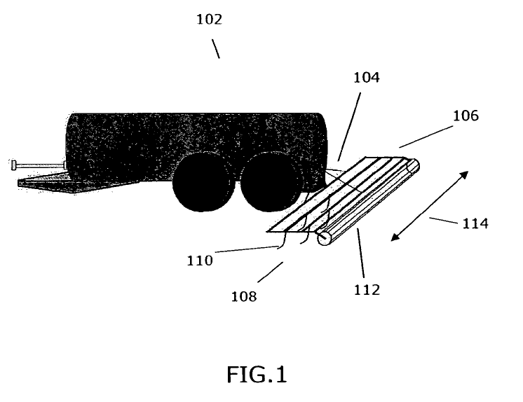

In FIG. 1, a known prior art system for soil working is shown in a perspective view. The figure shows a dragging device 102, in this example a manure tank to be dragged by an agricultural tractor (not shown). A connection 104 is used to connect the dragging device 102 with a frame 106 with soil working implements 108 intended for working the soil when dragged trough and/or over the soil. In this example the soil working implements comprises devices 110 for opening the soil and injecting manure into the soil and a device 112, a roller, for closing the soil again when the soil working implements are dragged through the soil and over the soil respectively. Other types of soil working implements may be connected to the frame in the known prior art system as well as in the invention and its embodiments described herein. As indicated on the figure a relatively small working width of the known art system is shown at 114.

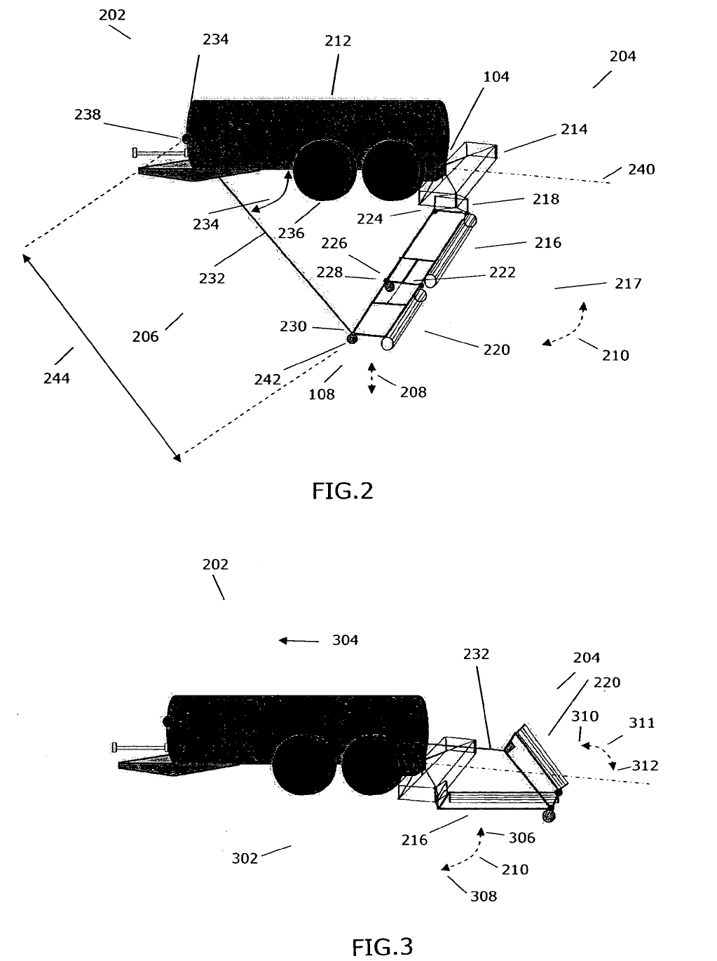

FIG. 2 shows an embodiment of a system 202 in accordance with the present invention in a perspective view. In FIG. 2 the frame 204 in shown in a working position 206. As indicated with a two way arrow 208 in the vertical plane 208 the frame can be supported, controlled and changed in a vertical direction or plane 208. As indicated with a rounded two way arrow in a horizontal plane the frame can also be supported, controlled and changed in a horizontal direction or plane 210 relative to an intended travelling direction of a dragging device 212.

The frame in the example comprises a centre frame section 214, possibly and preferably also with soil working implements (not shown), and additional frame sections 217. The additional frame sections are in this example an inner first frame section 216 pivotable connected to the centre frame 214 with a first pivotable connection 218 and an outer second frame section 220 pivotable connected to the inner first frame section 216 with a second pivotable connection 222. Both the inner first frame section and outer second frame section have first and second opposing ends 224, 226, 228, 230 as shown in which the frame sections are pivotable connected to each other.

A length adjustable connection 232, with a length as indicated at 244 in the given position of the frame, is shown between one of the frame sections, in this example the outer second end 230 of the frame section 220, and the dragging device 212. The length adjustable connection is arranged in an angle different from zero in both the vertical and horizontal planes. In this example the connection is intended to have an angle in the horizontal plane of approximately 45°'s relative to an intended travelling direction of the dragging device and a vertical angle of approximately 5°'s relative to the horizontal plane.

In order to provide these angles, a connection point of the length adjustable connection on the dragging device is positioned, in this example, at a front end 234 of the dragging device somewhat above an intended ground level 236 at an underside of a wheel of the dragging device and hereby somewhat above an intended level of a connection point of the other end of the length adjustable connection on a frame section.

Other positions of the connection point on the dragging device as well as on the frame are possible as long as the positions and angles provided hereby, such as angles during different positions of the frame, e.g. makes it possible to obtain drag forces created by the soil working implements when dragged through or over the soil and makes it possible by keeping or changing the length of the length adjustable connection to at least partly support and at least partly power a preservation or a change of the position of the frame and in order to support, control and change the frame in and between multiple positions of the frame.

The multiple positions of the frame, achieved by adjusting the length of the length adjustable connection, can be any position such as working positions needed when the travelling on an inclined piece of soil and possibly obtained by locking the pivotable connections to prevent rotating connected frame sections in the horizontal plane and unlocking the connections for pivoting the frames in the vertical plane in order to follow an inclination of the soil being worked. In particular one of the multiple positions can also or alternatively be a transport position of the frame, needed for decreasing the width of the frame in order to transport the frame, which will be further described in connection with the following FIG. 3.

Adjusting the length of the length adjustable connection is in this example, as in other examples herein, provided by a length adjuster 238 (not shown in detail), such as a motorised capstan or a winch for each length adjustable connection. The length adjuster is in this example positioned at the connection point on the dragging device. Operating the length is provided by a control system for operating the system so as to adjust the length of the length adjustable connection in order to obtain drag forces and follow the ground during working positions and/or in order to at least partly assists and at least partly power a change of the position of the frame, such as to and from the transport position.

Possibly the control system receives and operates in response to input information regarding a current position of the frame, a wanted position of the frame, current inclination of the ground etc. This input information may be provided by a number of sensors comprised in the system and connected to the control system such as distance-, position-, proximity- and strain sensors.

Possibly, other ways of adjusting the length of the length adjustable connection, in particular for e.g. relatively small adjustments, can be provided in addition to the described method for adjusting the length or as an alternative to the described. Such an additional or alternative way can be that the length adjuster is positioned on a slide, the slide being positioned on the dragging device and/or on a frame section, sliding in one or more directions as needed in order to change the length and/or the angle of the length adjustable connection. Although it can be preferred to position the length adjuster on the dragging device, e.g. in order to prevent increased weight of the frame, the length adjuster, or part of a length and/or angle adjusting system, may additionally or alternatively to a position on the dragging device, be positioned on the frame 204.

The transport position 302 of the system 202, comprising the frame 204 and length adjustable connection 232 along with other elements as described for FIG. 2, is shown in a similar perspective view in FIG. 3. The transport position may be achieved without the need to operate one or more of the pivotable connections, such as without locking or unlocking one or more of the pivotable connections in one or more directions, but may possibly be obtained as follows with reference to FIG. 2 and FIG. 3.

Changing the frame from the working position to the transport position may be achieved by moving the dragging device 212 in a forward travelling direction 304 and changing the length of the length adjustable connection 232 by increasing the length of the connection shown in FIG. 2. Hereby the first frame section 216 along with the second frame section 220 rotates in the horizontal plane, assisted by the length adjustable connection, in a direction towards a centre line 240 of the system as indicated with the arrow 306. When both the first frame section and the second frame section follow behind the dragging device in the forward travelling direction along the ground, the length of the length adjustable connection may be decreased. Hereby the second frame section 220 is folded or rotated in the vertical plane 311, powered by the length adjustable connection, in a direction as indicated at the arrow 310 to a position as shown in FIG. 3.

In other words, by providing certain angles as discussed and changing the length of the length adjustable connection, drag forces can be obtained and the frame is at least partly supported when changed from the working position to the transport position, and at least partly powered by the length adjustable connection.

Changing the frame from the transport position to the working position may similarly be achieved by increasing the length of the length adjustable connection as shown in FIG. 3 and travelling forward with the dragging device, hereby rotating the second frame 220 section in a backwards direction towards the arrow 312 in FIG. 3 and afterwards slowly lowering the second section—assisting the frame—to follow behind the dragging device along the ground. Afterwards the dragging device may be stopped and moved slightly backwards, possibly additionally or alternatively also decreasing the length of the length adjustable connection—at least partly powering the change—so as hereby to obtain the working position shown in FIG. 2.

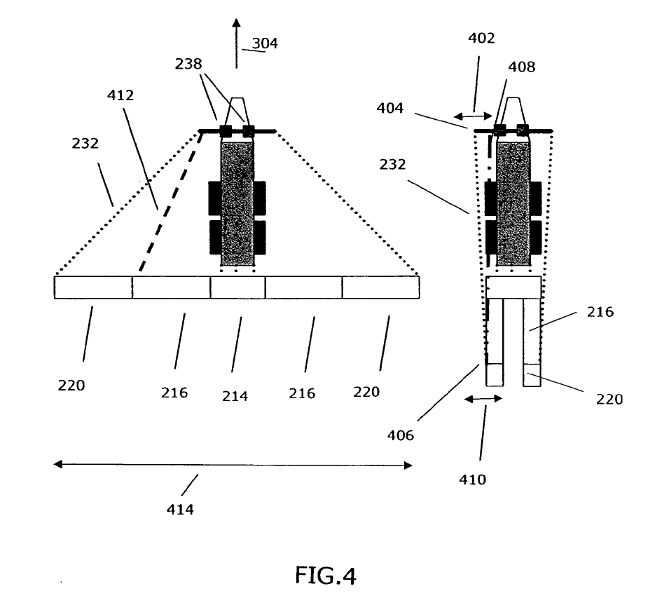

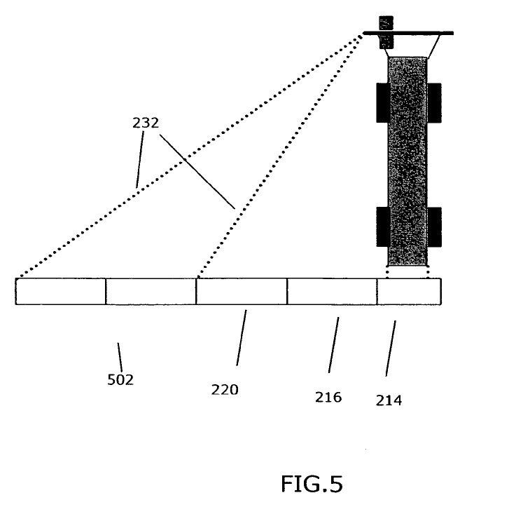

In general, possibly providing further means such as springs or similar means on the frame may help folding and unfolding the frame. Also sliding devices, as will be briefly discussed in connection with FIG. 4, may possibly help preserving an/or obtaining one or more of the multiple positions of the frame 204. Furthermore one or more adjustable wheels 242 may be connected to the frame 204 for helping the frame follow any inclinations in the soil and possibly as a help when changing the position of the frame.

For simplicity only one side of the system is shown and described in FIG. 2 and FIG. 3. Such a system 202 is possible, however in most situations a system 202 as the one described in FIG. 2 but with frame sections to both sides, as is shown in the system 202 in FIG. 4, can be preferred e.g. in order to have substantially equal drag forces from both sides of the system.

In FIG. 4 a top view of the first embodiment of the system in accordance with the invention is shown. It is shown that two length adjustable connections 232 is provided, one for each of left and a right side of the frame. Furthermore it is shown that each length adjustable connection is provided with the length adjuster 238 positioned side by side in the horizontal plane perpendicular to the forward travelling direction 304 in the front end of the dragging device.

Possibly and as indicated at 412 a further length adjustable connection may be provided and connected to the first frame section e.g. in order to relieve strain on the second pivotable connection 222 with the frame working in a work position and/or during change to and from working and transport positions. Preferably the further length adjustable connection has its own length adjuster (not shown in the figure).

The connection point of the length adjustable connection on the dragging device is shown positioned at a front end in a position 404 on the dragging device. As indicated with the two way arrow 402 a sliding means as previously described may be provided on the dragging device. When using the slide on the dragging device the connection point of the length adjustable connection may be changed to another position and hereby providing a changed angle as shown with the long dashed dotted line 408. Similarly, a sliding device for a connection point 406 on the frame may be provided.

It is indicated that the working width 414 of the system is relative large compared to a single section system as shown in FIG. 1 and as described further herein a possibility of improving the relation between the transport width of the system and the working width of the system (increasing the working width and/or decreasing the transport width) is also provided when compared to known multiple section systems.

FIG. 5 shows an embodiment of the present invention where two length adjustable connections 232 is provided for one side of the frame. Furthermore the frame is provided with further frame sections 502.

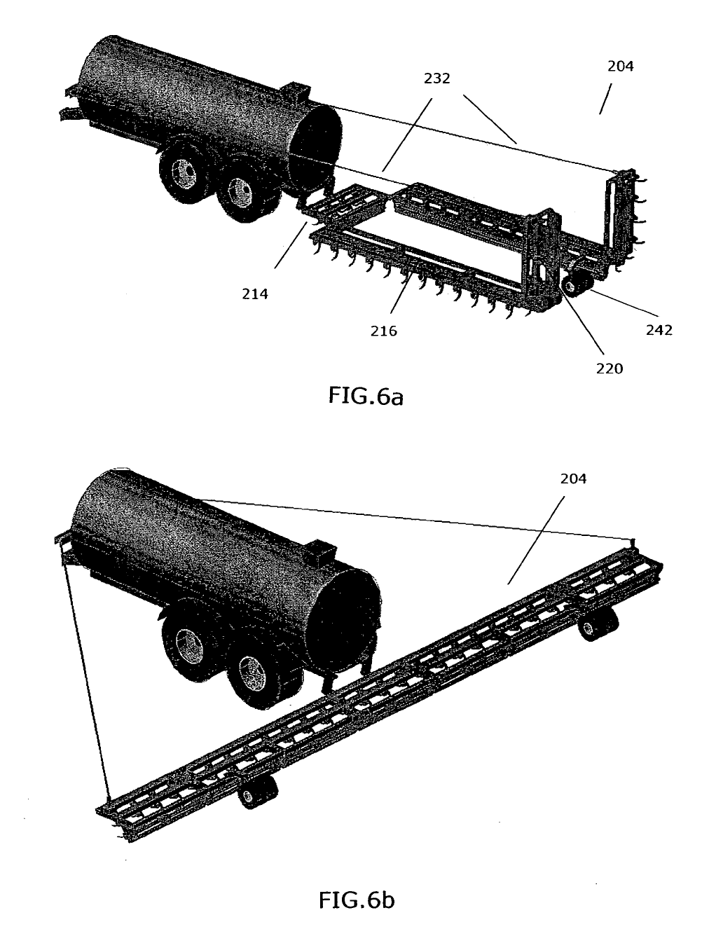

FIG. 6a and FIG. 6b shows solid drawings in perspective views of the first embodiment in accordance with the invention and its embodiments. The system is shown with the frame 204 in the transport position in FIG. 6a and with the frame in the working position in FIG. 6b. The elements shown are already described in connection with the previous figures; although certain elements are shown in more detail and certain elements, such as the length adjuster, is not shown in the figures.

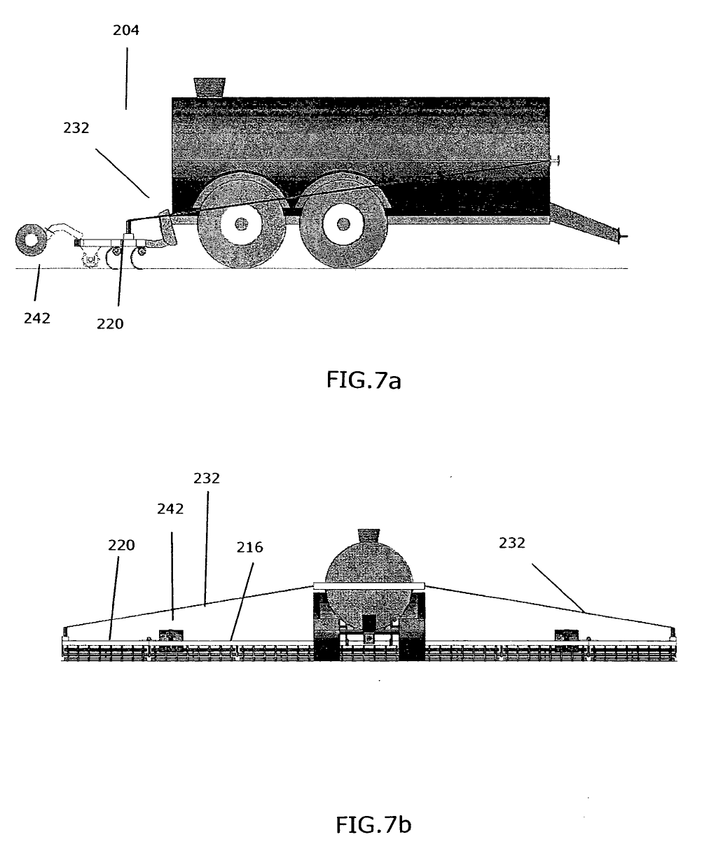

FIG. 7a and FIG. 7b shows solid drawings in a side and top view of the first embodiment in accordance with the invention and its embodiments. The system is shown with the frame 204 in the working position in both views.

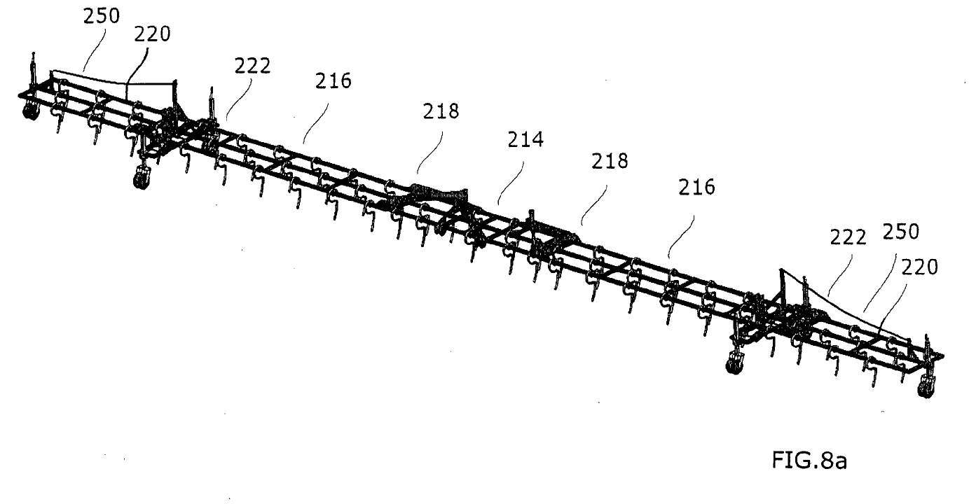

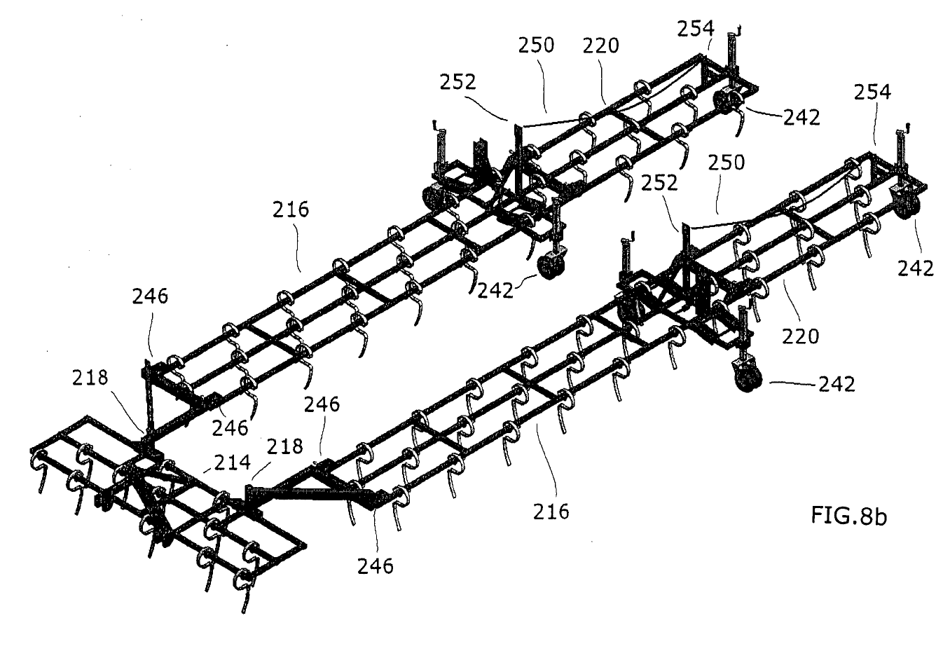

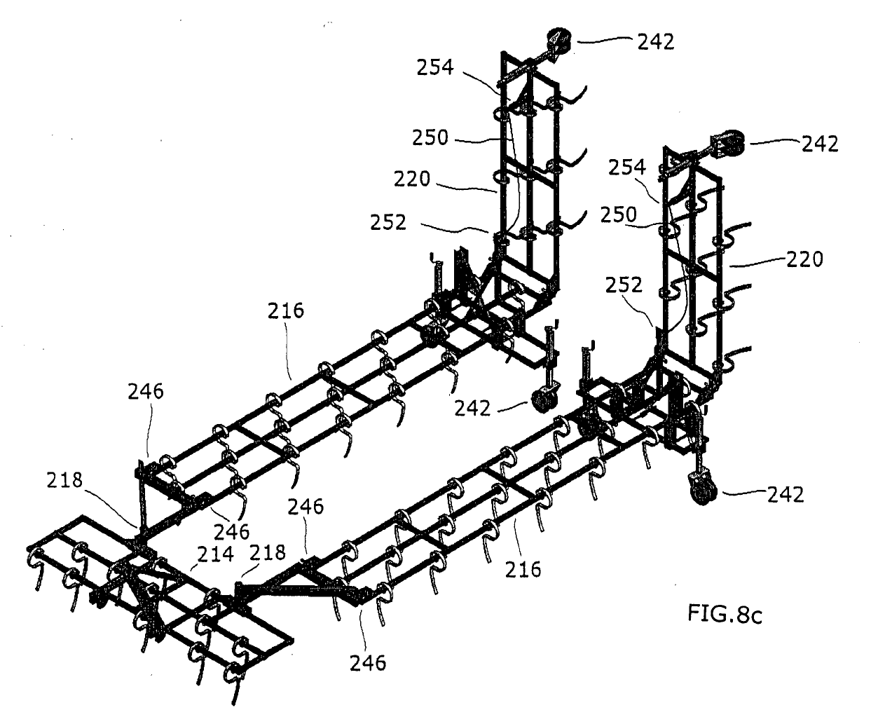

FIG. 8a, FIG. 8 and FIG. 8c shows a specific embodiment of the invention in a fully extended working position, see FIG. 8a, in a first partly collapsed position, see FIG. 8b, and in a second partly collapsed position, see FIG. 8c.

FIG. 8a, the fully extended position shows the centre frame section having two opposing ends. At each opposing end of the centre frame section, an inner first end 224 of inner first frame section 216 is connected. In the embodiment shown, the connection between the centre frame section 214 and the inner first frame sections 216 is established around a substantially first pivotable vertical hinge 218, said hinge being vertical when the soil working apparatus is extending along a horizontal level.

Each of the first frame sections 214 has an outer second end 226. At each outer second end 226 of the first frame sections 216, a first end 228 of outer second frame sections 220 is connected. In the embodiment shown, the connection between the first frame sections 216 and the second frame sections 220 is established around a second pivotable horizontal hinge 222, said hinge being horizontal when the soil working apparatus is extending along a horizontal level.

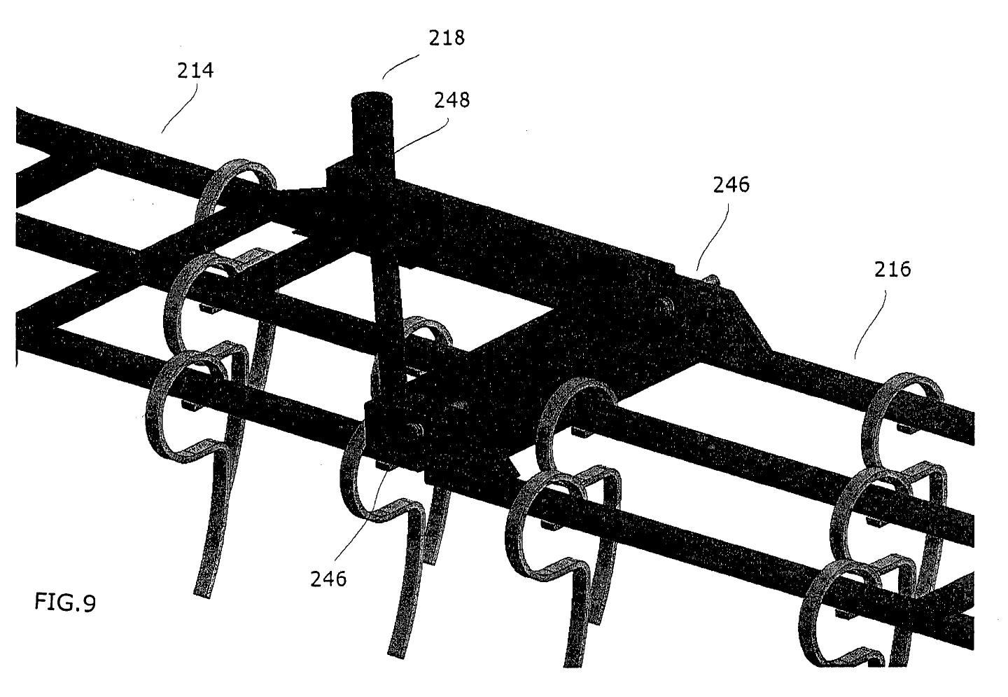

FIG. 9 is a close-up of the connection between the end of the centre frame section 214 and the first end 224 of one of the inner first frame section 216. Apart from the vertical hinge 218 between the centre frame section 214 and the first frame section 216, the first frame section 216 is also capable of pivoting around a third pivotable horizontal hinge 246 in relation to the centre frame section 214. A pivoting around a horizontal hinge 246 results in the first frame section 216 being capable of levelling up and down in relation to the centre frame section 214 so as to follow any contours of the field being worked by the soil working apparatus.

Rigidity of the connections 218 and 246 between the centre frame section and the first frame sections are provided by designing the connection as a triangle. The vertical hinge 218 is provided in one corner of the triangle and a crossbeam 248 extending from the vertical hinge 218 and to a front side of the first end 224 of the first frame section 216, i.e. where the highest torques is present during use of the soil working apparatus, directs the forces from the front side of the first end 224 of the first frame section 216 to the rotational axis of the vertical hinge 218.

FIG. 8a further described, the second frame sections 220 are connected to the first frame sections 216 around horizontal hinges 222. Therefore, the capability of levelling up and down in relation to the first frame sections 216 and in relation to the centre frame section 214 is already present in the connection 222 between the first frame sections 216 and the second frame sections 220. No further pivotable connections are needed for the second frame sections 220 being capable of levelling up and down so as to follow any contours of the field being worked.

In the embodiment shown, the pivotable connection 218 between the centre frame section 214 and the first frame sections 216 and the pivotable connections between the first frame sections 216 and the second frame sections 220 are pivoting hinges. However, in alternative embodiments of the soil working apparatus, all pivotable connections or some of the pivotable connections may be substituted by other means of pivoting the first frame sections 216 in relation to the centre frame section 214 and of pivoting the second frame sections 220 in relation to the first frame sections 216.

Alternative means for pivoting may be elastomeric connections having a built-in flexibility. Even alternative means of pivoting may be torsion bars extending between the frame sections and also establishing both a hinge-like connection and an elastic connection. Even alternative means of pivoting may be helical springs extending with the longitudinal axis along the intended axis of pivoting and acting as a kind of torsion bars.

In the embodiment shown, a level controlling connection 250 is provided between an upright beam 252 of the first frame sections 216 and an upright beam 254 of the second frame sections 220. In the embodiment shown, the level controlling connection 250 is preferably a chain. The chain 250 limits—to a certain degree, perhaps up to 15 degrees—the capability of the second frame sections 220 of levelling downwards in relation to the first frame sections 216.

In alternative embodiments, the chain 250 is substituted by a wire, a rope or a rigid rod, all preferably adjustable in length between the upright beams 252 and 254 of the first frame sections 216 and the second frame section 220, respectively. The level controlling connections 250 need not be attached to upright beams 252 and 254, but may be attached to the first frame sections 216 and to the second frame sections 220 in any manner suited for limiting the levelling downwards of the second frame sections 220.

Preferably, the degree of limiting the levelling downwards of the second frame sections 220 in relation to the first frame sections 216 may be adjustable, possibly by adjusting the length of the chain 250 between the upright beams 252, 254. A shorter chain 250 will limit the levelling downwards of the second frame section 220 in relation to the first frame sections 216 more than if the chain 250 is longer.

In the embodiment shown, the soil working apparatus is provided with set of wheels 242 for supporting the second outer end 226 of the first frame sections 216 and for supporting the outer second end 230 of the second frame sections 220. The level of the set of wheels 242 in relation to the frames 216, 220 is adjustable in order to adjust the penetration depth of the soil working implements of the apparatus, in the embodiment shown the penetration depth of manure injecting harrow implements into the soil. However, depending on the kind of soil working apparatus and thus of the soil working implements, one or both set of wheels 242 may be omitted.

FIG. 8b shows the soil working apparatus in a first partly collapsed position. The first frame sections 216 together with the second frame sections 220 are pivoted around the vertical hinges 218 provided between the ends of the centre frame section 214 and the first inner end 224 of the first frame sections 216. The first frame sections 216 together with the second frame sections 220 are each pivoted 90 degrees backwards in relation to a towing direction of the apparatus.

Pivoting is not established by hydraulics or the like. Pivoting is established either by increasing the length 244 of the length adjustable connection 232 (see e.g. FIG. 2 and FIG. 4) in comparison with the length in the working condition (see e.g. FIG. 2 and FIG. 4), i.e. the fully expanded working position (see FIG. 2 and FIG. 6b).

When the length 244 of the length adjustable connection 232 is increased, the first frame sections 216 together with the second frame sections 220 may pivot around the vertical hinges 218 by letting the first frame sections 216 together with the second frame sections 220 pivot backwards by dragging forces on the soil working implements, when the towing vehicle such as a tractor is moving forwards.

But the soil working apparatus cannot be transported in the position shown in FIG. 8b.

FIG. 8c shows the soil working apparatus in a second partly collapsed position. The first frame sections 216 together with the second frame sections 220 are pivoted around the vertical hinges 218 between the ends of the centre frame section 214 and the inner first ends 224 of the first frame sections 216 as shown in FIG. 8b. Furthermore, the second frame sections 220 are each pivoted 90 degrees upwards in relation to the first frame sections 216 around the horizontal hinges 222.

Pivoting is not established by hydraulics or the like. Pivoting is established either by decreasing the length 244 of the length adjustable connection 232 (see e.g. FIG. 6a) and letting the second frame sections 220 pivot upwards around the horizontal hinges 222 by means of dragging forces when the length 244 of the length adjustable connection 232 is decreased.

The soil working apparatus may be transported in the position shown in FIG. 8c by letting the set of wheels 242 of the first frame sections 216 support the first frame sections 216 while being dragged along by the towing vehicle such as a tractor, said dragging being accomplished via the centre frame section 214 attached to the towing vehicle.

However, the length of the towing vehicle such as a tractor together with both the length of the dragging device 212 and the length of the first frame sections 216 in the position shown in FIG. 8c may still make it difficult transporting the soil working apparatus.

Therefore, a further collapsing of the apparatus may be provided (not shown), where the first frame sections 216 are pivoted upwards around the possible additional horizontal hinges 246 between the centre frame section 214 and the inner first end 224 of the first frame sections 216 (see FIG. 9). The first frame sections 216 need not be pivoted more upwards than enough to just free the set of wheels 242 from the ground. However, the more the first frame sections 216 are lifted, together with the second frame section 220, the more will the total length of the towing vehicle, the dragging device and the frame 204 be limited. A limitation of the total length may be beneficial when transporting the frame. Possibly, the first frame sections 216 may be lifted upright and the second frame sections 220 will thus extending forwards above the dragging device 212.

Thereby, the first frame sections 216 are hanging freely, suspended between the ends of the centre frame section 214 and the inner first ends228 of the second frame sections 220. The first frame sections 216 are maintained in suspended position by the same length adjustable connections 232 as those pivoting the second frame sections 220. The lifting of the first frame sections 216 is established by further decreasing the length 244 of the length adjustable connections 232 compared to the initial increase of length 244, when pivoting the second frame sections 220 in relation to the first frame sections 216 (see FIG. 8c).

It has to be noted, that lifting of the first frame sections 216 also depends on the geometrical relations between the position of the length adjustable connection 232 on the dragging device 212 and of the position of the length adjustable connection 232 on the second frame sections 220. Torques may arise inhibiting lifting of the first frame sections and/or further decrease of the length 244 of the length adjustable connections 232 may result in a dragging force not capable of lifting the first frame sections 216.

Thus, in the embodiments shown in FIG. 6a-6b and FIG. 7a-7b, the possibility of also lifting the first frame sections 216 may not be present due to the position of the length adjustable connections 232 on the dragging device 212 and on the second frame sections 220. However, by use of pulleys or the like devices (not shown) for diverting the longitudinal extension of the length adjustable connections 232 or by another positioning of the length adjustable connections 232 on the dragging device 212 and/or on the second frame sections 220, the possibility of also lifting the first frame sections 216 by means of the length adjustable connections 232 may be established and accomplished.

It also has to be noted, that the embodiments shown in FIG. 6a-6b and in FIG. 7a-7b are specific embodiments. Other dragging devises and/or other soil working apparatuses may have designs better suited for the possibility of also lifting the first frame section.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practiced in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the embodiments shown and described, the first pivotable connections 218, is described as being vertical hinges or other types of pivotable connections. However, in alternative embodiments, the pivotable connection 218 need not pivot around a vertical axis. An axis obliquely to a vertical axis may also be envisaged, possibly a pivotable connection having an axis of pivoting lying in a plane between vertical and 45 degrees to vertical. However, in order of not inhibiting pivoting of the first frame sections 216 when being positioned in the partly collapsed position (see FIG. 8b), a vertical axis is preferred.

In the embodiments shown and described, the second pivotable connections 222, is described as being horizontal hinges or other types of pivotable connections. However, in alternative embodiments, the pivotable connection 222 need not pivot around a horizontal axis. An axis obliquely to a horizontal axis may also be envisaged, possibly a pivotable connection having an axis of pivoting lying in a plane between horizontal and 45 degrees to horizontal. However, in order of obtaining a capability of the second frame sections 220 levelling upwards and downwards, a horizontal axis is preferred.

In the embodiments shown, the centre frame section is shown and described as also being provided with soil working implements such as manure injecting harrow implements. However, in alternative embodiments, the centre frame section need only be a section for suspending the first frame sections to the dragging device. Thus, the centre section need not take part in the soil working as such, but may be an intermediate structure between the first frame sections and the dragging device. Also, the dragging device itself may comprise the centre frame section, the centre frame section thus constituting part of the dragging device.

Even in the alternative or additional to any alternatives, the dragging device as such may be part of the towing vehicle. Thus, the dragging device may be a three-point hoist of the dragging device or may be a hook of the towing vehicle. Thus, no additional vehicle such as a manure container vehicle as shown and described in the embodiments need be provided for utilising the system and for performing the method of the invention.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims, however the inclusion of the reference signs is only for clarity reasons and should not be construed as limiting the scope of the claims.

Elsewhere herein it is described that a system 202 is disclosed with a frame 204 with a plurality pivotable connected frame sections 214,216,220,502, the frame 204 being operable in a number of positions 206,302 and changeable between these, and a length adjustable connection 232 between at least one of the frame sections and a dragging device 212, wherein the length adjustable connection 232 is arranged in an angle 234 and a length 244 of the length adjustable connection is controlled so as to obtain drag forces created by working the soil, and the length adjustable connection 232 is so arranged that changing the length 244 of the length adjustable connection at least partly supports and at least partly powers a change of the position 206,302 of the frame in order e.g. to provide an improved relation between a transport width and a soil working width of the frame 204 and for supporting, controlling and changing between multiple positions 206, 302.

1. A system for supporting, controlling and changing between multiple positions of a frame, the frame being intended for being dragged by a dragging device and for use with agricultural soil working implements connected with the frame, the soil working implements creating drag forces when used, the system comprising:
the frame comprising a plurality pivotable connected frame sections being operable in a number of positions and changeable between these positions, and wherein the frame comprises:
a centre frame section having a left and right side end and wherein the centre frame section is provided for being connected to the dragging device, and said frame furthermore comprising:
one or more additional frame sections pivotable connected by one or more pivotable connections to the centre frame section in at least one of the left and right side ends of the centre frame section, said additional frames frame sections comprising:
a first frame section having first and second opposing ends and being pivotable connected to the centre frame section on one side of the centre frame section in the first end;
a second frame section having first and second opposing ends and being pivotable connected to the second end of the first frame section in the first end, and wherein the system furthermore comprises:
a length adjustable connection between at least one of the additional first and second frame sections and the dragging device, wherein
the length adjustable connection is arranged in an angle between the additional frame sections and the dragging machine and wherein,
a length of the length adjustable connection is controlled so as to obtain drag forces from the soil working implements when being dragged by the dragging device, and wherein the length adjustable connection is so arranged that changing the length of the length adjustable connection at least partly supports and at least partly powers a change of the position of the frame, and so arranged that changing the length of the length adjustable connection at least partly supports and at least partly powers a change of position of the frame in both a first plane and a second plane, wherein the first plane is a substantially horizontal plane and wherein the second plane is a substantially vertical plane.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A system according to claim 1, wherein the length adjustable connection is so arranged and operated that changing the length of the length adjustable connection at least partly assists and at least partly powers the change of position of the frame in both horizontal and vertical planes when changing the frame between the working position and the transport position.

15. A system according to claim 1, wherein the length adjustable connection is so arranged and operated that changing the length of the length adjustable connection at least partly assists and at least partly powers the change of position of the frame in both horizontal and vertical planes when changing the frame to and from the working position and to and from the transport position

16. A system according to claim 1, wherein the one or more pivotable connections is capable of being locked or unlocked in one or more directions.

17. A system according to claim 1, wherein the centre frame section is provided for extending in a substantially horizontal direction substantially perpendicular to a travelling direction of the dragging device.

18. A system according to claim 1, wherein the length adjustable connection is connected between an outer end of one of the one or more additional frame sections and the dragging device.

19. A system according to claim 1, wherein the length of the length adjustable connection is adjusted by changing a length of a flexible but substantially non-extendable line such as a wire connected between one of the one or more additional frame sections and the dragging device.

20. A system according to claim 1, wherein a level controlling connection is provided between the first frame section and the second frame section, and wherein said connection has a length limiting a downwards pivoting of the second frame section in relation to the first frame section.

21. A system according to claim 1, wherein the level controlling connection is has a length limiting the downwards pivoting of the second frame section to a level of 45 degrees, 30 degrees, or 15 degrees below horizontal level, when the first frame section is at a horizontal level.

22. A system according to claim 1, wherein the frame is provided for being connected to a dragging device selected from the group consisting of a frame carrier, a self propelled frame carrier, an agricultural tractor, and a frame carrier that is drawn by an agricultural tractor.

23. A system according to claim 1, wherein a connection between the frame and the dragging device is selected from the group consisting of a pivotable connection, a non-pivotable but releasable connection, a fixed non-releasable connection, a hitching device, and a three point hitching device.

24. A control system for operating a system according to claim 1 so as to adjust the length of the length adjustable connection in order to provide a system which is capable of obtaining drag forces and which is capable of at least partly assisting and at least partly powering a change of the position of the frame.

25. A method for supporting, controlling and changing between multiple positions of a frame in a system, the frame being intended for being dragged by a dragging device and for use with agricultural soil working implements connected with the frame, the soil working implements creating drag forces when used, the system comprising:
the frame comprising a plurality pivotable connected frame sections, the frame being operable in a number of positions and changeable between these positions, and
a length adjustable connection between at least one of the frame sections and the dragging device, said method comprising:
arranging the length adjustable connection and controlling a length of the length adjustable connection so as to obtain drag forces from the soil working implements, and
changing the length of the length adjustable connection so as to at least partly support and at least partly power a change of the position of the frame, in both a first plane and a second plane, wherein the first plane is a substantially horizontal plane and wherein the second plane is a substantially vertical plane.
